(19) United States
(12) Patent Application Publication
(10) Pub. No.: US 2022/0073421 A1
(43) Pub. Date: Mar. 10, 2022

(54) Glass Substrate Multilayer Structure, Method of Producing the Same, and Flexible Display Panel Including the Same

(71) Applicants: SK Innovation Co., Ltd., Seoul (KR); SK ie technology Co., Ltd., Seoul (KR)

(72) Inventor: Cheol Min Yun, Daejeon (KR)

(21) Appl. No.: 17/460,904

(22) Filed: Aug. 30, 2021

(30) Foreign Application Priority Data
Sep. 4, 2020 (KR) 10-2020-0112853

(51) Int. Cl. C03C 17/32; G09F 9/30; C03C 17/34

(52) U.S. Cl. CPC C03C 17/326; C03C 2217/78; C03C 17/3405; G09F 9/301

(57) ABSTRACT

Provided are a glass multilayer structure, a method of producing the same, and a flexible display panel including the same. Specifically, a glass substrate multilayer structure including: a flexible glass substrate, a polyimide-based shatterproof layer formed on one surface of the flexible glass substrate, and an epoxy siloxane-based hard coating layer formed on the shatterproof layer, and a flexible display panel including the same are provided.

### CROSS-REFERENCE TO RELATED APPLICATION

This application claims priority to Korean Patent Application No. 10-2020-0112853 filed Sep. 4, 2020, the disclosure of which is hereby incorporated by reference in its entirety.

### BACKGROUND OF THE INVENTION

### Field of the Invention

The following disclosure relates to a glass substrate multilayer structure, a method of producing the same, and a flexible display panel including the same.

### Description of Related Art

In recent years, thinner display devices are required with the development of mobile devices such as smart phones and tablet PCs, and among them, a flexible display device which may be curved or foldable when a user wants or a flexible display device of which the manufacturing process includes curving or folding is receiving attention.

The display device includes a transparent window covering a display screen, and the window has a function of protecting the display device from external impact, scratches applied during the use, and the like.

Glass or tempered glass which is a material having excellent mechanical properties is generally used for a window for displays, but conventional glass has no flexibility and results in a higher weight of a display device due to its weight.

In order to solve the problem described above, a technology to make a flexible glass substrate thinner has been developed, but is not sufficient for implementing flexible properties capable of being curved or bent, and the problem of being easily broken by an external impact has currently yet to be solved.

In particular, in the case of a flexible display device, a glass substrate window is easily broken by external impact or in the process of curving or folding and the fragments shatter to cause a user to be injured. In addition, in order to solve the above, efforts have been made to solve the problems by further forming a functional layer such as a shatterproof layer and a hard coating layer (or a surface hardness layer), but when a glass multilayer structure is shrunk and expanded by thermal hysteresis or the like, a problem of deformation of a glass substrate and deformation of a glass multilayer structure in which the functional layer is formed has yet to be solved.

Accordingly, the development of a novel glass substrate multilayer structure, which has improved durability, may improve a shattering phenomenon when the glass substrate is broken to secure a user's safety, and has improved thermal resistance and optical properties, and simultaneously, for solving deformation problems of a glass substrate and glass substrate multilayer structure due to an external stress such as the thermal hysteresis, is currently needed.

### SUMMARY OF THE INVENTION

An embodiment of the present invention may be realized by providing a novel glass substrate multilayer structure, which, when a thin film glass substrate is used as a substrate, prevents a bending occurrence in edge portions or center portions of a glass substrate due to thermal shrinkage and thermal expansion by curing when forming a shatterproof layer and a hard coating layer.

Another embodiment of the present invention may be realized by providing a glass substrate multilayer structure, which has excellent surface hardness and may have a small thickness but excellent impact resistance properties to be applied to a flexible display device.

Still another embodiment of the present invention may be realized by providing a glass substrate multilayer structure capable of being applied to a flexible display device, which has excellent durability and shatter resistant properties to secure a user's safety, has flexible properties to allow being curved or bent, so that glass is not broken or not cracked even when repeating curving or folding.

In one general aspect, a glass substrate multilayer structure includes: a flexible glass substrate; a polyimide-based shatterproof layer formed on one surface of the flexible glass substrate; and an epoxy siloxane-based hard coating layer formed on the polyimide-based shatterproof layer, wherein the polyimide-based shatterproof layer has a coefficient of thermal expansion (CTE) at 100° C. to 200° C. of 50 to 80 ppm.

As an exemplary embodiment of the present invention, the polyimide-based shatterproof layer may be formed of a polyimide resin including a unit derived from a fluorine-based aromatic diamine and a unit derived from an aromatic dianhydride.

As an exemplary embodiment of the present invention, the epoxy siloxane-based hard coating layer may be formed of an epoxy siloxane-based resin including a unit derived from an alicyclic epoxidized silsesquioxane-based compound.

As an exemplary embodiment of the present invention, the flexible glass substrate may have a thickness of 1 to 100 μm.

As an exemplary embodiment of the present invention, the polyimide-based shatterproof layer may have a thickness of 100 nm to 5 μm.

As an exemplary embodiment of the present invention, the polyimide-based shatterproof layer may have a pencil hardness of HB in accordance with ASTM D3363.

As an exemplary embodiment of the present invention, the polyimide-based shatterproof layer may have a value in a range of +1.5 mm to +2.0 mm in bending properties.

The bending properties are obtained by measuring a bending degree of the glass substrate multilayer structure at room temperature, immediately after forming the polyimide-based shatterproof layer on a glass substrate having a width of 180 mm×a length of 76 mm×a thickness of 40 μm. When the glass substrate multilayer structure is curved in a direction of a vibration isolation table and a center of the glass substrate is curved to an air layer, the value is represented as a negative (stress) value (mm) and conversely, when both ends (edges) of the glass substrate are curved in a direction of the air layer on the vibration isolation table, the value is represented as a positive (tension) value (mm).

As an exemplary embodiment of the present invention, the epoxy siloxane-based hard coating layer may have a thickness of 1 μm to 5 μm.

As an exemplary embodiment of the present invention, the epoxy siloxane-based hard coating layer may have a pencil hardness of 4H to 6H in accordance with ASTM D3363.

As an exemplary embodiment of the present invention, the epoxy siloxane-based hard coating layer may have a transmittance of 90% or more.

As an exemplary embodiment of the present invention, the epoxy siloxane-based hard coating layer may have a value in a range of −1.0 mm to −1.5 mm in bending properties.

The bending properties are obtained by measuring a bending degree of the glass substrate multilayer structure at room temperature, immediately after forming the hard coating layer on a glass substrate having a width of 180 mm×a length of 76 mm×a thickness of 40 μm. When the glass substrate multilayer structure is curved in a direction of a vibration isolation table and a center of the glass substrate is curved to an air layer, the value is represented as a negative (stress) value (mm) and conversely, when both ends (edges) of the glass substrate are curved in a direction of the air layer on the vibration isolation table, the value is represented as a positive (tension) value (mm).)

As an exemplary embodiment of the present invention, the glass substrate multilayer structure may have shatter resistance of 1 m or more in accordance with a ball drop test.

As an exemplary embodiment of the present invention, the glass substrate multilayer structure may have a value within ±0.5 mm in bending properties.

The bending properties are obtained by measuring a bending degree of the glass substrate multilayer structure at room temperature, immediately after forming the polyimide-based shatterproof layer and the hard coating layer on a glass substrate having a width of 180 mm×a length of 76 mm×a thickness of 40 μm. When the glass substrate multilayer structure is curved in a direction of a vibration isolation table and a center of the glass substrate is curved to an air layer, the value is represented as a negative (stress) value (mm) and conversely, when both ends (edges) of the glass substrate are curved in a direction of the air layer on the vibration isolation table, the value is represented as a positive (tension) value (mm).

In another general aspect, a method of producing a glass substrate multilayer structure includes: applying a shatterproof composition on one surface of a flexible glass substrate and curing the shatterproof composition to form a polyimide-based shatterproof layer; and applying a hard coating composition on the polyimide-based shatterproof layer and curing the hard coating composition to form an epoxy siloxane-based hard coating layer.

As an exemplary embodiment of the present invention, the shatterproof composition may include a fluorine-based aromatic diamine and an aromatic dianhydride.

As an exemplary embodiment of the present invention, the epoxy siloxane-based hard coating composition may include an epoxy siloxane-based resin including a unit derived from an alicyclic epoxidized silsesquioxane-based compound, a crosslinking agent, and a photoinitiator.

In still another general aspect, a flexible display panel includes the glass substrate multilayer structure.

Other features and aspects will be apparent from the following detailed description, the drawings, and the claims.

### BRIEF DESCRIPTION OF THE DRAWING

FIG. 1 is an exploded perspective view which schematically shows a cross-section of a glass multilayer structure according to an exemplary embodiment of the present invention.

### DETAILED DESCRIPTION OF MAIN ELEMENTS

10: flexible glass substrate

20: polyimide-based shatterproof layer

30: epoxy siloxane-based hard coating layer

100: glass substrate multilayer structure

### DESCRIPTION OF THE INVENTION

The terms used in the present disclosure have the same meanings as those commonly understood by a person skilled in the art. In addition, the terms used herein are only for effectively describing a certain specific example, and are not intended to limit the present disclosure.

The singular form used in the specification of the present disclosure and the claims appended thereto may be intended to also include a plural form, unless otherwise indicated in the context.

Throughout the present specification describing the present disclosure, unless explicitly described to the contrary, “comprising” any elements will be understood to imply further inclusion of other elements rather than the exclusion of any other elements.

The terms such as “first” and “second” used in the present specification may be used to describe various constituent elements, but the constituent elements are not to be limited by the terms. The terms are used only to distinguish one constitutional element from another constitutional element.

The term “flexible” in the present disclosure refers to being curved, bent, or folded.

The term “shatterproof layer” in the present disclosure is used to refer to including a “polyimide-based shatterproof layer”.

The term “hard coating layer” in the present disclosure is used to refer to including an “epoxy siloxane-based hard coating layer”.

The term “within” in the present disclosure is used to refer to an inclusion range and as a specific example, “within ±0.5 mm” is used to refer to a range including +0.5 mm and −0.5 mm.

The inventors of the present disclosure conducted many studies to solve the above problems, and as a result, found a glass substrate multilayer structure which implements flexible properties and has excellent shatter resistant properties, impact resistance properties, and optical properties so as to be appropriate for application to a cover window of a flexible display panel, by forming a polyimide-based shatterproof layer on one surface of a flexible glass substrate and forming an epoxy siloxane-based hard coating layer on the polyimide-based shatterproof layer, and thus, completed the present disclosure.

In addition, it was confirmed that the polyimide-based shatterproof layer adopts a polyimide, in particular, a polyimide having a coefficient of thermal expansion (CTE) value at 100 to 200° C. of 50 to 80 ppm, thereby having an effect of not causing the short-term or long-term deformation of the flexible glass substrate due to various external stresses such as thermal hysteresis, and also having an effect of interacting with the deformation of an epoxy siloxane-based hard coating layer to also suppress the deformation such as bending of the polyimide-based shatterproof layer and the epoxy siloxane-based hard coating layer.

Furthermore, it was found that by forming the thickness of the polyimide-based shatterproof layer of the present disclosure to have a thickness of 5 μm or less, the effect of preventing the deformation such as bending of the glass substrate multilayer structure may be further controlled well, and shatter resistant properties, thermal resistance, and optical properties are excellent, and thus, the present invention was completed.

Hereinafter, each constituent of the present disclosure will be described in detail with reference to a drawing. However, these are only illustrative and the present disclosure is not limited to the specific embodiments which are illustratively described in the present disclosure.

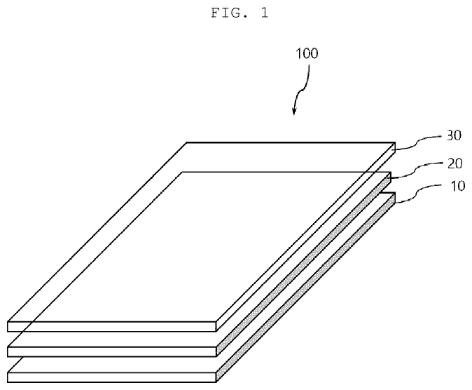

FIG. 1 is a schematic drawing illustrating a glass substrate multilayer structure according to an exemplary embodiment of the present invention.

As seen in FIG. 1, the glass substrate multilayer structure 100 according to an exemplary embodiment of the present invention includes a polyimide-based shatterproof layer 20 formed on one surface of a flexible glass substrate 10 and an epoxy siloxane-based hard coating layer 30 formed on the polyimide-based shatterproof layer 20.

The glass substrate multilayer structure according to an exemplary embodiment of the present invention may have a pencil hardness of 3H or more, specifically 4H or more, in accordance with ASTM D3363. In addition, the glass substrate multilayer structure may have shatter resistant properties of 1 m or more, more specifically 1.5 m or more, and still more specifically 2 m or more by a ball drop test. Here, the ball drop test refers to a state of no pressing, nicks, or cracks on the surface when a steel ball having a weight of 130 g and a diameter of 30 mm was dropped.

The glass substrate multilayer structure according to an exemplary embodiment of the present invention may have a value within ±0.8 mm, specifically within ±0.5 mm or ±0.45 mm in bending properties.

The bending properties are obtained by measuring a bending degree of the glass substrate multilayer structure at room temperature, immediately after forming the polyimide-based shatterproof layer and the hard coating layer on a glass substrate having a width of 180 mm×a length of 76 mm×a thickness of 40 μm. When the glass substrate multilayer structure is curved in a direction of a vibration isolation table and a center of the glass substrate is curved to an air layer, the value is represented as a negative (stress) value (mm) and conversely, when both ends (edges) of the glass substrate are curved in a direction of the air layer on the vibration isolation table, the value is represented as a positive (tension) value (mm).

The polyimide forming the polyimide-based shatterproof layer in the glass substrate multilayer structure according to an exemplary embodiment of the present invention may have a modulus of 4 GPa or less, 3.8 GPa or less, or 3.5 GPa or less in accordance with ASTM E111 and an elongation at break of 30% to 60%.

In addition, the polyimide forming the polyimide-based shatterproof layer in the glass substrate multilayer structure according to an exemplary embodiment of the present invention may have a modulus of 4 GPa or less, 3.8 GPa or less, or 3.5 GPa or less in accordance with ASTM E111, an elongation at break of 30% to 60%, a light transmittance measured at 388 nm of 5% or more or 5 to 80% and a total light transmittance measured at 400 to 700 nm of 87% or more, 88% or more, or 89% or more, in accordance with ASTM D1746, a haze of 2.0% or less, 1.5% or less, or 1.0% or less in accordance with ASTM D1003, a yellow index of 5.0 or less, 3.0 or less, or 0.4 to 3.0 in accordance with ASTM E313, and a b* value of 2.0 or less, 1.3 or less, or 0.4 to 1.3.

The glass substrate multilayer structure according to an exemplary embodiment of the present invention adopts a polyimide having a coefficient of thermal expansion (CTE) value at 100° C. to 200° C. of 50 to 80 ppm, and the polyimide-based shatterproof layer is formed on one surface of the flexible glass substrate and an epoxy siloxane-based hard coating layer is formed on the polyimide-based shatterproof layer.

By forming as such, the deformation of the flexible glass substrate due to a stress (for example, various external stresses such as thermal hysteresis) is suppressed, and also the bending occurrence of the glass multilayer structure due to the deformation of the epoxy siloxane-based hard coating layer is also suppressed, thereby imparting an effect of significantly improving the deformation resistance of the glass substrate multilayer structure of the present disclosure as a whole.

In particular, the polyimide-based shatterproof layer has a thickness of 5 μm or less, thereby decreasing the entire thickness of the glass substrate multilayer structure produced, and implementing further improved surface hardness and shatter resistant properties.

Furthermore, the glass substrate multilayer structure according to an exemplary embodiment of the present invention may easily implement flexible properties with excellent flexibility as well as the effect described above, and has excellent impact resistance and shatter resistant properties, thereby securing a user's safety, and is transparent with excellent optical properties, so that it may be applied as a window cover of a flexible display panel.

Hereinafter, referring to FIG. 1, each component of a flexible glass substrate 10, a polyimide-based shatterproof layer 20, and an epoxy siloxane-based hard coating layer 30 will be described in more detail.

<Flexible Glass Substrate>

A flexible glass substrate refers to a foldable or curved glass substrate, may function as a window of a display device, and has good durability and excellent surface smoothness and transparency.

In an exemplary embodiment of the present invention, a glass substrate multilayer structure 100 may be formed on one surface of a flexible display panel 100 or may be curved or folded in response to curving or folding. Here, in order for the glass substrate multilayer structure 100 to be deformed so as to be bent with a relatively small radius of curvature or be roughly folded, a flexible glass substrate 10 may be formed of an ultra-thin glass substrate. Specifically, the flexible glass substrate 10 may be an ultra-thin glass substrate, and may have a thickness of 100 μm or less, specifically 1 to 100 μm or 30 to 100 μm.

In an exemplary embodiment of the present invention, the flexible glass substrate may further include a chemical reinforcement layer, and the chemical reinforcement layer may be formed by performing a chemical reinforcement treatment on any one or more surfaces of a first surface and a second surface of a glass substrate included in the flexible glass substrate, thereby improving the strength of the flexible glass substrate.

There are various methods of forming a chemical reinforcement-treated ultra-thin flexible glass substrate, and as an example, a method of preparing an original long glass having a thickness of 100 μm or less, processing the glass into a predetermined shape by cutting, chamfering, sintering, and the like, and subjecting the processed glass to a chemical reinforcement treatment may be included. As another example, an original long glass having a normal thickness is prepared and slimmed into a thickness of 100 μm or less, and then may be subjected to shape processing and a chemical reinforcement treatment sequentially. Here, slimming may be performed by any one selected from a mechanical method and a chemical method or both in combination.

<Polyimide-Based Shatterproof Layer>

In an exemplary embodiment of the present invention, the polyimide-based shatterproof layer may have a basic function to absorb energy generated when the glass substrate 10 is damaged, thereby preventing fragments of the glass substrate 10 from shattering. In addition, by forming a polyimide-based shatterproof layer having specifically a coefficient of thermal expansion (CTE) at 100° C. to 200° C. of 50 to 80 ppm, the stress of the hard coating layer and the glass substrate may be adjusted to prevent the long-term deformation or the short-term deformation due to an external stress such as thermal hysteresis. Specifically, the polyimide-based shatterproof layer may have a thickness of 5 μm or less, thereby effectively suppressing the deformation of the flexible glass substrate and the hard coating layer and also implementing a glass substrate multilayer structure having a surface hardness of 4H or more, 5H or more, or 6H or more.

In an exemplary embodiment of the present invention, the polyimide-based shatterproof layer may implement an effect of suppressing the deformation such as bending and deformation of the flexible glass substrate due to an external stresses such as thermal shrinkage and also suppressing the deformation of the epoxy siloxane-based hard coating layer described later, when a polyimide, in particular, a polyimide containing a fluorine element is included to form a shatterproof layer, and the polyimide forming the polyimide-based shatterproof layer has a modulus of 4 GPa or less, 3.8 GPa or less, or 3.5 GPa or less in accordance with ASTM E111 and an elongation at break of 30% to 60%.

In addition, in an exemplary embodiment of the present invention, the polyimide-based shatterproof layer may have a pencil hardness of HB under a load of 750 gf in accordance with ASTM D3363.

In an exemplary embodiment of the present invention, when the polyimide-based shatterproof layer is formed of a polyimide-based resin including a unit derived from a fluorine-based aromatic diamine and a unit derived from an aromatic dianhydride, specifically formed of a polyimideimide-based resin polymerized from a monomer including the fluorine-based aromatic diamine and the aromatic dianhydride, optical physical properties and mechanical physical properties are excellent and elasticity and restoration force are excellent, and also, an effect of preventing deformation of the glass substrate may be further enhanced.

In an exemplary embodiment of the present invention, as the fluorine-based aromatic diamine, any one or two or more selected from 1,4-bis(4-amino-2-trifluoromethylphenoxy)benzene (6FAPB), 2,2′-bis(trifluoromethyl)benzidine (TFMB), 2,2′-bis(trifluoromethyl)-4,4′-diaminodiphenyl ether (6FODA), and the like may be used. In addition, the fluorine-based aromatic diamine may be used in combination with other known aromatic diamine components, but the present invention is not limited thereto. By using the fluorine-based aromatic diamine as such, deformation of the glass substrate due to thermal hysteresis or the like by the polyimide-based shatterproof layer produced may be suppressed, shatter resistant properties may be further improved, optical properties may be further improved, and also a yellow index may be improved.

In an exemplary embodiment of the present invention, the aromatic dianhydride may be any one or two or more selected from 4,4′-hexafluoroisopropylidene diphthalic anhydride (6FDA), biphenyltetracarboxylic dianhydride (BPDA), oxydiphthalic dianhydride (ODPA), sulfonyl diphthalic anhydride (SO2DPA), (isopropylidenediphenoxy) bis(phthalic anhydride) (6HDBA), 4-(2,5-dioxotetrahydrofuran-3-yl)-1,2,3,4-tetrahydronaphthalene-1,2-dicarboxylic dianhydride (TDA), 1,2,4,5-benzene tetracarboxylic dianhydride, benzophenone tetracarboxylic dianhydride (BTDA), bis(carboxylphenyl) dimethyl silane dianhydride (SiDA), bis(dicarboxyphenoxy) diphenyl sulfide dianhydride (BDSDA), pyromellitic dianhydride (PMDA), ethylene glycol bis(anhydrotrimellitate) (TMEG100), and the like, but is not limited thereto.

In an exemplary embodiment of the present invention, the fluorine-based aromatic diamine and the aromatic dianhydride may be used at a mole ratio of 1.5:1 to 1:1.5, specifically 1.3:1 to 1:1.3, or 1.2:1 to 1:1.2, but is not limited thereto.

In an exemplary embodiment of the present invention, the polyimide-based shatterproof layer may have a thickness of 5 μm or less, and the lower limit is not particularly limited, but may be 10 nm.

In an exemplary embodiment of the present invention, the polyimide-based shatterproof layer has a value of shatter resistant properties of 1 m or more, specifically 1.3 m or more, more specifically 1.5 m or more, still more specifically 2 m or more, and further specifically 2.5 m or more in accordance with a ball drop test. The shatter resistant properties in accordance with the ball drop test is a measurement of a height at which, when a steel ball having a diameter of 30 mm and a weight of 130 g is dropped, the glass substrate multilayer structure is not nicked and damaged.

In an exemplary embodiment of the present invention, the polyimide-based shatterproof may have a value within a range of +1.5 mm to +2.0 mm in bending properties.

The bending properties are obtained by measuring a bending degree of the glass substrate multilayer structure at room temperature, immediately after forming the polyimide-based shatterproof layer on a glass substrate having a width of 180 mm×a length of 76 mm×a thickness of 40 μm. When the glass substrate multilayer structure is curved in a direction of a vibration isolation table and a center of the glass substrate is curved to an air layer, the value is represented as a negative (stress) value (mm) and conversely, when both ends (edges) of the glass substrate are curved in a direction of the air layer on the vibration isolation table, the value is represented as a positive (tension) value (mm).

<Hard Coating Layer>

Next, a hard coating layer will be described in detail.

The hard coating layer may function to protect the glass substrate multilayer structure from external physical and chemical damage and may have excellent optical and mechanical properties.

In an exemplary embodiment of the present invention, the hard coating layer 30 may be formed on the polyimide-based shatterproof layer 20, and is not limited as long as it is formed by including a known hard coating layer forming material, but as an example, may be formed by including an epoxy siloxane-based resin.

In an exemplary embodiment of the present invention, the epoxy siloxane-based resin may include a silsesquioxane-based compound as a main component. Specifically, the silsesquioxane-based compound may be an alicyclic epoxidized silsesquioxane (epoxidized cycloalkyl substituted silsesquioxane)-based compound.

An example of the alicyclic epoxidized silsesquioxane-based compound may include a trialkoxysilane compound-derived repeating unit represented by the following Chemical Formula 1:

A-Si(OR)₃ [Chemical Formula 1]

wherein A is a C1 to C10 alkyl group substituted by a C2 to C7 epoxy group, R is independently of each other a C1 to C10 alkyl group, and the carbon of the C1 to C10 alkyl group may be substituted by oxygen.

In Chemical Formula 1, an example of the epoxy group may be a cycloalkyl-fused epoxy group, and a specific example thereof may include a cyclohexylepoxy group and the like.

Here, a specific example of the alkoxysilane compound may be one or more of 2-(3,4-epoxycyclohexyl)methyltrimethoxysilane, 2-(3,4-epoxycyclohexyl)ethyltrimethoxysilane, 2-(3,4-epoxycyclohexyl)methyltriethoxysilane, 2-(3,4-epoxycyclohexyl)ethyltriethoxysilane, 3-glycidoxypropyltrimethoxysilane, but the present disclosure is not limited thereto.

In addition, in an exemplary embodiment of the present invention, the silsesquioxane-based compound also includes a diakoxysilane compound-derived repeating unit represented by the following Chemical Formula 2, together with the trialkoxysilane compound-derived repeating unit represented by Chemical Formula 1. In this case, the silsesquioxane-based compound may be prepared by mixing 0.1 to 100 parts by weight of the dialkoxysilane compound with respect to 100 parts by weight of the trialkoxysilane compound and performing condensation polymerization:

A-siRₐ(OR)₂ [Chemical Formula 2]

wherein Rₐ is a linear or branched alkyl group selected from C1 to C5, and A and R are as defined in Chemical Formula 1.

A specific example of the compound of Chemical Formula 2 may include 2-(3,4-epoxycyclohexyl)ethylmethyldimethoxysilane, 2-(3,4-epoxycyclohexyl)ethylpropyldimethoxysilane, 2-(3,4-epoxycyclohexyl)ethylmethyldiethoxysilane, 2-(3,4-epoxycyclohexyl)ethylmethyldiethoxysilane, and the like, but is not limited thereto, and the compound may be used alone or in combination of two or more.

In an exemplary embodiment of the present invention, the hard coating layer may further include inorganic particles, and the inorganic particles may include any one or two or more selected from the group consisting of silica and metal oxides.

A specific example of the metal oxide may include alumina, titanium, and the like, and though it is not limited thereto, for example, silica may be used in terms of compatibility with other components of the hard coating composition described later. These may be used alone or in combination of two or more. In addition, the inorganic particles may further include particles selected from a hydroxide such as aluminum hydroxide, magnesium hydroxide, and potassium hydroxide; metal particles such as gold, silver, copper, nickel, and an alloy thereof; conductive particles such as carbon, carbon nanotube, and fullerene; glass; ceramic; and the like, but are not limited thereto.

In an exemplary embodiment of the present invention, the inorganic particles may have an average particle diameter of 1 to 200 nm, and specifically, 5 to 180 nm, and within the average particle diameter range, inorganic particles having two or more different average particle diameters may be used, but are not limited thereto.

In addition, the hard coating layer may further include a lubricant. The lubricant may improve winding efficiency, blocking resistance, wear resistance, scratch resistance, and the like. As a specific example of the lubricant, waxes such as polyethylene wax, paraffin wax, synthetic wax, or montan wax; synthetic resins such as silicon-based resin and fluorine-based resin; and the like may be used, and these may be used alone or in combination of two or more.

In an exemplary embodiment of the present invention, the epoxy siloxane-based hard coating layer may have a thickness of 10 μm or less, specifically 1 μm to 10 μm, more specifically 1 μm to 8 μm, and still more specifically 2.5 μm to 5 μm.

When the epoxy siloxane-based hard coating layer has the thickness in the above range, it may sufficiently suppress bending by the polyimide-based shatterproof layer described above, the entire thickness of the glass substrate multilayer structure produced is further thinned, and flexibility is maintained while having excellent hardness, and thus, bending of the glass substrate multilayer structure may substantially not occur.

In an exemplary embodiment of the present invention, the epoxy siloxane-based hard coating layer has a pencil hardness of 3H or more, 4H or more, 5H or more, or 6H or more, and the upper limit is not limited, but for example, may be 6H. In addition, the epoxy siloxane-based hard coating layer may have no scratches at 10 times/1 Kgf, 20 times/1 Kgf, or 30 times/1 Kgf in scratch evaluation using steel wool (#0000, from Reveron), and may have a water contact angle of 80° or more, 90° or more, or 100° or more. In addition, the epoxy siloxane-based hard coating layer may have a transmittance of 90% or more, specifically 95% or more, or 99% or more.

The epoxy siloxane-based hard coating layer may have a value within a range of −1.0 mm to −1.5 mm in bending properties.

Here, the bending properties are obtained by measuring a bending degree of the glass substrate multilayer structure at room temperature, immediately after forming the hard coating layer on a glass substrate having a width of 180 mm×a length of 76 mm×a thickness of 40 μm. When the glass substrate multilayer structure is curved in a direction of a vibration isolation table and a center of the glass substrate is curved to an air layer, it is represented as a negative (stress) value (mm) and conversely, when both ends (edges) of the glass substrate are curved in a direction of the air layer on the vibration isolation table, it is represented as a positive (tension) value (mm).

<Flexible Display Panel>

In an exemplary embodiment of the present invention, a flexible display panel or a flexible display device including the glass substrate multilayer structure according to the exemplary embodiment as a window cover may be provided.

In an exemplary embodiment of the present invention, a glass substrate multilayer structure 100 in the flexible display device may be used as an outermost surface window substrate of the flexible display panel. The flexible display device may be various image displays such as a common liquid crystal display device, an electroluminescent display device, a plasma display device, and a field emission display device.

<Method of Producing Glass Substrate Multilayer Structure>

Hereinafter, a method of producing a glass substrate multilayer structure according to an exemplary embodiment of the present invention will be described in detail.

The method of producing a glass substrate multilayer structure according to an exemplary embodiment of the present invention may include: applying a shatterproof composition on one surface of a flexible glass substrate and curing the shatterproof composition to form a polyimide-based shatterproof layer; and applying a hard coating composition on the polyimide-based shatterproof layer and curing the hard coating composition to form an epoxy siloxane-based hard coating layer.

First, a shatterproof composition in forming the polyimide-based shatterproof layer will be described.

In an exemplary embodiment of the present invention, the shatterproof composition may include a fluorine-based aromatic diamine and an aromatic dianhydride, and the fluorine-based aromatic diamine and the aromatic dianhydride may be the same as those described above. As a specific exemplary embodiment, the shatterproof composition may be a polyimide precursor prepared by dissolving the fluorine-based aromatic diamine in an organic solvent to obtain a mixed solution, to which the aromatic dianhydride is added to perform a polymerization reaction. Here, the reaction may be carried out under an inert gas or a nitrogen stream, or under anhydrous conditions. In addition, the temperature during the polymerization reaction may be −20° C. to 200° C. or 0° C. to 180° C., and the organic solvent which may be used in the polymerization reaction may be a solvent having a boiling point (bp) of 110 to 170° C. and a specific example thereof may be selected from N,N-diethylacetamide (DEAc), N,N-diethylformamide (DEF), N-ethylpyrrolidone (NEP), dimethylpropaneamide (DMPA), diethylpropaneamide (DEPA), or a mixture thereof.

The organic solvent may be included at 30 to 40 wt % with respect to the total weight of the shatterproof composition, but is not limited thereto. Here, the polyimide precursor solution may be in the form of a solution dissolved in an organic solvent or may be a dilution of the solution in other solvents. In addition, when the polyimide precursor is obtained as a solid powder, this may be dissolved in an organic solvent to form a solution.

Thereafter, the polyimide precursor may be imidized, thereby preparing a polyimide solution (shatterproof composition). Here, as the imidization process, a known imidization method may be used without limitation, but a specific example includes a chemical imidization method, a thermal imidization method, and the like, and in an exemplary embodiment of the present invention, an azeotropic thermal imidization method may be used.

In the azeotropic thermal imidization method, toluene or xylene is added to a polyimide precursor (polyamic acid solution) and stirring is carried out to perform an imidization reaction at 160° C. to 200° C. for 6 to 24 hours, during which water released while an imide ring is produced may be separated as an azeotropic mixture of toluene or xylene.

The polyimide solution prepared according to the above preparation method may have excellent solvent resistance, and may include a solid content in an amount to have an appropriate viscosity, considering processability such as coatability.

According to a specific exemplary embodiment, the shatterproof composition (polyimide solution) may have a solid content of 1 to 30 wt %, specifically 5 to 25 wt %, or 8 to 20 wt %. Here, the shatterproof composition may have a viscosity of 100 mPa·s to 5,000 mPa·s at 25° C. and 1 atm, but is not limited thereto.

Hereinafter, a method of forming a polyimide-based shatterproof layer will be described.

In an exemplary embodiment of the present invention, the physical properties of the present disclosure of the polyimide-based shatterproof layer may be more easily obtained by applying the shatterproof composition on each of the front and rear surfaces of the flexible glass substrate and adding a further hardening fixation. Here, the application method is not limited, but various methods such as bar coating, dip coating, die coating, gravure coating, comma coating, slit coating, or a combined method thereof may be used.

An additional curing step after the coating may be a heat treatment at a temperature of 150° C. to 250° C., the number of heat treatments may be one or more, and the heat treatment may be performed once or more at the same temperature or in different temperature ranges. In addition, the heat treatment time may be minute to 60 minutes, but is not limited thereto. By the additional curing, the shatterproof layer having a coefficient of thermal expansion (CTE) of 50 ppm to 80 ppm in a section of 100 to 200° C. required in the present disclosure may be formed well.

Hereinafter, the hard coating layer in forming the epoxy siloxane-based hard coating layer, according to an exemplary embodiment of the present invention, will be described.

In an exemplary embodiment of the present invention, the hard coating composition may include the epoxy siloxane-based resin described above, a crosslinking agent, and a photoinitiator, and specifically, may include an epoxy siloxane-based resin including a unit derived from the alicyclic epoxidized silsesquioxane-based compound described above, a crosslinking agent, and a photoinitiator.

In an exemplary embodiment of the present invention, the crosslinking agent may form crosslinks with the epoxy siloxane-based resin to solidify the hard coating layer forming composition and improve the hardness of the hard coating layer.

The crosslinking agent may contain, for example, a compound represented by the following Chemical Formula 3, and the compound represented by Chemical Formula 3 is the same alicyclic epoxy compound as the epoxy unit of the structures of Chemical Formulae 1 and 2, and may promote crosslinks and maintain a refractive index of the hard coating layer to cause no change in a viewing angle, may maintain bending properties, and may not damage transparency:

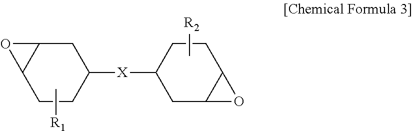

wherein R₁ and R₂ are independently of each other hydrogen or a linear or branched alkyl group having 1 to 5 carbon atoms, and X is a direct bond; a carbonyl group; a carbonate group; an ether group; a thioether group; an ester group; an amide group; a linear or branched alkylene group, an alkylidene group, or an alkoxylene group having 1 to 18 carbon atoms; a cycloalkylene group or a cycloalkylidene group having 1 to 6 carbon atoms; or a linking group thereof.

Here, a “direct bond” refers to a structure which is directly bonded without any functional groups, and for example, in Chemical Formula 3, may refer to two cyclohexanes being directly connected to each other. In addition, a “linking group” refers to two or more substituents described above being connected to each other. In addition, in Chemical Formula 3, the substitution positions of R1 and R2 are not particularly limited, but when the carbon connected to X is set at position No. 1 and the carbons connected to an epoxy group are set at position Nos. 3 and 4, R1 and R2 may be substituted at position No. 6.

The content of the crosslinking agent is not particularly limited, and for example, may be 1 to 150 parts by weight with respect to 100 parts by weight of the epoxysilane-based resin. Within the content range, the viscosity of the hard coating composition may be maintained in an appropriate range, and coatability and curing reactivity may be improved.

In addition, in an exemplary embodiment of the present invention, the hard coating layer may be used by adding various epoxy compounds in addition to the compounds of the above chemical formulae, and the content may not exceed 20 parts by weight with respect to 100 parts by weight of the compound of Chemical Formula 3, but is not limited thereto as long as the features of the present disclosure are achieved.

In an exemplary embodiment of the present invention, the epoxy-based monomer may be included at 10 to 80 parts by weight with respect to 100 parts by weight of the hard coating layer forming composition. Within the content range, viscosity may be adjusted, a thickness may be easily adjusted, a surface is uniform, defects in a thin film do not occur, and hardness may be sufficiently achieved, but the present invention is not limited thereto.

In an exemplary embodiment of the present invention, the photoinitiator is a cationic photoinitiator, and may initiate condensation of an epoxy-based monomer including the compounds of the above chemical formulae. As the cationic photoinitiator, for example, an onium salt and/or an organic metal salt, and the like may be used, but the present invention is not limited thereto. For example, a diaryliodonium salt, a triarylsulfonium salt, an aryldiazonium salt, an iron-arene complex, and the like may be used, and these may be used alone or in combination of two or more.

The content of the photoinitiator is not particularly limited, and for example, may be 0.1 to 10 parts by weight or 0.2 to 5 parts by weight with respect to 100 parts by weight of the compound of Chemical Formula 1.

In an exemplary embodiment of the present invention, a non-limiting example of the solvent may include alcohol-based solvents such as methanol, ethanol, isopropanol, butanol, methyl cellosolve, and ethyl cellosolve; ketone-based solvents such as methyl ethyl ketone, methyl butyl ketone, methyl isobutyl ketone, diethyl ketone, dipropyl ketone, and cyclohexanone; hexane-based solvents such as hexane, heptane, and octane; benzene-based solvents such as benzene, toluene, and xylene; and the like. These may be used alone or in combination of two or more.

In an exemplary embodiment of the present invention, the solvent may be included in a residual amount excluding an amount of the remaining components in the total weight of the composition.

As a non-limiting exemplary embodiment, the hard coating layer forming composition may further include a thermal curing agent.

The thermal curing agent may include a sulfonium salt-based curing agent, an amine-based curing agent, an imidazole-based curing agent, an acid anhydride-based curing agent, an amide-based thermal curing agent, and the like, and a sulfonium-based thermal curing agent may be further used in terms of prevention of discoloration and implementation of high hardness. These may be used alone or in combination of two or more.

The content of the thermal curing agent is not particularly limited, and for example, may be 5 to 30 parts by weight with respect to 100 parts by weight of the epoxy siloxane resin. When the thermal curing agent is contained in the above range, the hardness efficiency of the hard coating layer forming composition may be further improved to form a hard coating layer having excellent hardness.

In an exemplary embodiment of the present invention, by using the hard coating layer forming composition, the glass substrate multilayer structure may be physically protected, mechanical physical properties may be further improved, and bending durability may be further improved.

The method of polymerizing an alicyclic epoxidized silsesquioxane-based compound according to the present disclosure is not limited as long as it is known in the art, but for example, may be prepared by hydrolysis and condensation reactions between alkoxy silanes represented by Chemical Formulae 1 and 2 in the presence of water. Here, the hydrolysis reaction may be promoted by including a component such as an inorganic acid. In addition, the epoxy siloxane-based resin may be formed by polymerizing a silane compound including an epoxycyclohexyl group.

Here, the alicyclic epoxidized silsesquioxane-based compound may have a weight average molecular weight of 1,000 to 20,000 g/mol, and within the weight average molecular weight range, the hard coating layer forming composition may have an appropriate viscosity to improve flowability, coatability, curing reactivity, and the like.

In addition, the hardness of the hard coating layer prepared may be improved. Also, the flexibility of the hard coating layer may be improved to suppress a curl occurrence. The alicyclic epoxidized silsesquioxane-based compound may have a weight average molecular weight of 1,000 to 18,000 g/mol or 2,000 to 15,000 g/mol, but is not limited thereto. Here, the weight average molecular weight is measured using GPC.

Hereinafter, a method of forming an epoxy siloxane-based hard coating layer will be described.

In an exemplary embodiment of the present invention, the epoxy-based hard coating layer may be prepared by applying the hard coating composition on the first polyimide-based shatterproof layer and curing the hard coating composition. Here, the application method is not limited, but various methods such as bar coating, dip coating, die coating, gravure coating, comma coating, slit coating, or a combined method thereof may be used.

The curing may be performed by photocuring or thermal curing alone, or thermal curing after photocuring or photocuring after thermal curing. Here, the thermal curing may be performed at 150° C. to 200° C.

As a non-limiting exemplary embodiment, the curing step may further include a drying step before the photocuring, and the drying may be performed at 30° C. to 70° C. for 1 to 30 minutes, but the present invention is not limited thereto.

In an exemplary embodiment of the present invention, by using the hard coating composition, the glass substrate multilayer structure may be physically protected and the mechanical physical properties may be further improved.

Hereinafter, the present disclosure will be described in more detail with reference to the Examples and Comparative Examples. However, the following Examples and Comparative Examples are only an example for describing the present disclosure in more detail, and do not limit the present disclosure in any way.

Hereinafter, the physical properties were measured as follows:

1) Pencil Hardness

A pencil hardness on a surface of a glass substrate multilayer structure produced in the Examples and the Comparative Examples was measured using pencils by hardness (Mitsubishi Pencil Co., Ltd.) under a load of 750 g using a pencil hardness tester (Kipae E&T Co. Ltd.), in accordance with ASTM D3363. The surface of the glass substrate multilayer structure refers to a surface on which a hard coating layer is formed.

2) Evaluation of Shatter Resistant Properties (Ball Drop Test)

Evaluation was performed at room temperature using a ball drop measuring instrument from Nano Hitec. A multilayer structure was placed on a sample support, a steel ball having a weight of 130 g and a diameter of 30 mm was dropped on a glass substrate multilayer structure sample produced in the following Examples and Comparative Example 1 from a height of 1 m, and then the state of the glass substrate multilayer structure was evaluated according to the following criteria. The ball drop was measured by dropping the ball on the surface having a hard coating layer formed thereon.

<Evaluation Criteria>

⊚: no nicks and pressing

◯: nicks and pressing present

x: broken (not shattered)

▴: different results in two evaluations

3) Average Coefficient of Thermal Expansion (CTE)

Heating and strong heating were performed to 200° C. twice at a rate of 5° C. per minute with 0.02 N, using TMA (Thermomechanical Analyzer, TA instrument), a coefficient of thermal expansion was measured in the second heating, and an average value of the coefficients of thermal expansion measured in a temperature section of 100° C. to 200° C. was determined. The unit is ppm/° C.

4) Bending Properties

The glass substrate multilayer structures produced in the following Examples and Comparative Examples were placed on a flat ground and a degree to which the glass substrate multilayer structure was bent upward or downward was measured, and when the edge portions of the glass substrate were bent upward, the value was shown as +, and when the portions were bent or curved downward, the value was shown as −.

Specifically, on a glass substrate having a width of 180 mm×a length of 76 mm×a thickness of 40 μm, each shatterproof layer and hard coating layer forming composition was applied and cured, and immediately after that, the glass substrate multilayer structure was placed on a correctly leveled vibration isolation table, and the bending of the glass substrate multilayer structure was measured at room temperature. Here, when the glass substrate multilayer structure was curved in a direction of the vibration isolation table and a center of the glass substrate was curved to an air layer, a step difference from the highest curve point portion of the center was measured based on the edge and shown as a negative (stress) value (mm), and conversely, when the both ends (edges) of the glass substrate were curved in a direction of the air layer on the vibration isolation table, a step difference of a raised edge was measured based on the center and shown as a positive (tension) value (mm).

5) Young's modulus/elongation at break was measured by using UTM 3365 available from Instron, under a condition of pulling a polyamideimide film having a thickness of 10 μm, a length of 50 mm, and a width of 10 mm at 5 mm/min at 25° C., in accordance with ASTM E111. The unit of the Young's modulus is GPa and the unit of the elongation at break is %.

### [Preparation Example 1] 6FAPB/TMEG100

An agitator in which a nitrogen stream flowed was filled with 230 g of (N,N-dimethylpropionamide (DMPA), and 36.5 g of 2,2′-bis(trifluoromethyl)-4,4′-diaminodiphenyl ether (6FODA) was dissolved while the temperature of a reactor was maintained at 25° C. 35 g of ethylene glycol bis(anhydrotrimellitate) (TMEG100) was added to the 6FAPB solution at the same temperature, and dissolved with stirring for a certain period of time. 70 g of toluene was added to a polyimide precursor solution prepared from the above reaction, a reflux was performed at 180° C. for 6 hours to remove water, and dimethylpropaneamide (DMPA) was added so that a solid content concentration was 20 wt % to prepare a shatterproof layer forming composition (polyimide solution).

### [Preparation Example 2] TFMB/TMEG100

An agitator in which a nitrogen stream flowed was filled with 267 g of N,N-dimethylpropionamide (DMPA), and 39 g of 2,2′-bis(trifluoromethyl)-4,4′-biphenyl diamine (TFMB) was dissolved while the temperature of the reactor was maintained at 25° C. 50 g of ethylene glycol bis-anhydro trimellitate (TMEG100) was added to the TFMB solution at the same temperature, and dissolved with stirring for a certain period of time. 55 g of toluene was added to a polyimide precursor solution prepared from the above reaction, a reflux was performed at 180° C. for 6 hours to remove water, and dimethylpropaneamide (DMPA) was added so that a solid content concentration was 20 wt % to prepare a shatterproof layer forming composition (polyimide solution).

### [Preparation Example 3] 6FODA/TMEG100

An agitator in which a nitrogen stream flowed was filled with 153 g of N,N-dimethylpropionamide (DMPA), and 41 g of 2,2′-bis(trifluoromethyl)-4,4′-diaminophenylether (6FODA) was dissolved while the temperature of the reactor was maintained at 25° C. 50 g of ethylene glycol bis-anhydro trimellitate (TMEG100) was added to the 6FODA solution at the same temperature, and dissolved with stirring for a certain period of time. 50 g of toluene was added to a polyimide precursor solution prepared from the above reaction, a reflux was performed at 180° C. for 6 hours to remove water, and dimethylpropaneamide (DMPA) was added so that a solid content concentration was 20 wt % to prepare a shatterproof layer forming composition (polyimide solution).

### [Preparation Example 4] 6FODA/TPER/TMEG100

An agitator in which a nitrogen stream flowed was filled with 238 g of N,N-dimethylpropionamide (DMPA), and 18.4 g of 2,2′-bis(trifluoromethyl)-4,4′-diaminophenylether (6FODA) and 16.0 g of 1,3-bis(4-aminophenoxy)benzene (TPER) were dissolved while the temperature of the reactor was maintained at 25° C. 45 g of ethylene glycol bis-anhydro trimellitate (TMEG100) was added to the 6FODA/TPER solution at the same temperature, and dissolved with stirring for a certain period of time. 95 g of toluene was added to a polyimide precursor solution prepared from the above reaction, a reflux was performed at 180° C. for 6 hours to remove water, and dimethylpropaneamide (DMPA) was added so that a solid content concentration was 20 wt % to prepare a shatterproof layer forming composition (polyimide solution).

### [Preparation Example 5] TFMB/PMDA

An agitator in which a nitrogen stream flowed was filled with 116 g of N,N-dimethylpropionamide (DMPA), and 22.78 g of 2,2′-bis(trifluoromethyl)benzidine (TFMB) was dissolved while the temperature of the reactor was maintained at 25° C. 16 g of Pyromellitic dianhydride (PMDA) was added to the TFMB solution at the same temperature, and dissolved with stirring for a certain period of time. To the polyimide precursor solution prepared from the above reaction, dimethylpropaneamide (DMPA) was added so that a solid content concentration was 20 wt % to prepare a shatterproof layer forming composition (polyimide solution).

### [Preparation Example 6] Preparation of Epoxy Siloxane-Based Hard Coating Layer Forming Composition

2-(3,4-epoxycyclohexyl)ethyltrimethoxysilane (ECTMS, TCI) and water were mixed at a ratio of 24.64 g: 2.70 g (0.1 mol: 0.15 mol) to prepare a reaction solution and the reaction solution was added to a 250 mL 2-neck flask. 0.1 mL of a tetramethylammonium hydroxide catalyst (Aldrich) and 100 mL of tetrahydrofuran (Aldrich) were added to the mixture and stirring was performed at 25° C. for 36 hours. Thereafter, layer separation was performed and a product layer was extracted with methylene chloride (Aldrich), moisture was removed from the extract with magnesium sulfate (Aldrich), and the solvent was dried under vacuum to obtain an epoxy siloxane-based resin. The weight average molecular weight of the epoxy siloxane-based resin was measured using gel permeation chromatography (GPC), and the result was 2,500 g/mol.

30 g of the epoxy siloxane-based resin as prepared above, g of (3′,4′-epoxycyclohexyl)methyl 3,4-epoxycyclohexanecarboxylate and 5 g of bis[(3,4-epoxycyclohexyl)methyl] adipate as a crosslinking agent, 0.5 g of (4-methylphenyl)[4-(2-methylpropyl)phenyl]iodoniumhexafluorophosphate as a photoinitiator, and 54.5 g of methylethyl ketone were mixed to prepare a hard coating composition.

<Measurement of Physical Properties of Shatterproof Layer>

### Experimental Example 1

Each composition prepared in Preparation Examples 1 to 5 was applied on one surface of a glass substrate (UTG 40 μm) with a #8 mayer bar, dried at 50° C. for 1 minute, and dried at 230° C. for 10 minutes to form a shatterproof layer having a thickness of 3.0 μm.

The physical properties of the shatterproof layer formed using the each of the compositions of Preparation Examples 1 to and the glass substrate multilayer structure on which the shatterproof layer was formed were measured and are shown in the following Table 1.

TABLE 1

| | Preparation | Preparation | Preparation | Preparation | Preparation |
|---|---|---|---|---|---|
| Composition | Example 1 | Example 2 | Example 3 | Example 4 | Example 5 |
| Coating thickness | 3.0 | 3.0 | 3.0 | 3.0 | 3.0 |
| (unit: μm) | | | | | |
| Young's modulus of | 1.8 | 2.3 | 2.9 | 3.5 | 7.5 |
| shatterproof layer | | | | | |
| (unit: GPa) | | | | | |
| Bending properties | 1.7 | 1.7 | 1.8 | 1.8 | −1.5 |
| of multilayer | | | | | |
| structure (unit: mm) | | | | | |
| CTE of | 78 | 73 | 71 | 65 | −15 |
| shatterproof layer | | | | | |
| (unit: ppm/° C.) | | | | | |

In addition, the surface hardness of the shatterproof layer formed on the glass substrate in Preparation Example 3 was measured as HB.

<Production of Glass Substrate Multilayer Structure>

### Example 1

The shatterproof layer forming composition prepared in Preparation Example 1 was applied on one surface of a glass substrate (UTG 40 μm) with a #8 mayer bar, dried at 50° C. for 1 minute, and dried at 230° C. for 10 minutes to form a shatterproof layer having a thickness of 5.0 μm. Then, the hard coating layer forming composition prepared in Preparation Example 6 was coated on the shatterproof layer with a #10 bar, dried at 65° C. for 3 minutes, and irradiated with an ultraviolet ray of 300 mJ/cm² to produce a glass substrate multilayer structure on which a hard coating layer having a thickness of 4.8 μm was formed.

### Example 2

A glass substrate multilayer structure was produced in the same manner as in Example 1, except that the shatterproof layer was formed using the shatterproof layer forming composition prepared in Preparation Example 2.

### Example 3

A glass substrate multilayer structure was produced in the same manner as in Example 1, except that the shatterproof layer was formed using the shatterproof layer forming composition prepared in Preparation Example 3.

### Example 4

A glass substrate multilayer structure was produced in the same manner as in Example 1, except that the shatterproof layer was formed using the shatterproof layer forming composition prepared in Preparation Example 4.

### Examples 5 to 10

Glass substrate multilayer structures were produced in the same manner as in Example 3, except that the thickness of the shatterproof layer was formed to be 0.5 μm, 1.0 μm, 1.5 μm, 2.0 μm, 2.5 μm, and 3.0 μm, respectively, and the thickness of the hard coating layer was formed to be 4.8 μm.

### Examples 11 to 16

Glass substrate multilayer structures were produced in the same manner as in Example 5 to 10 except that the thickness of the hard coating layer was formed to be 4.0 μm.

### Examples 17 to 22

Glass substrate multilayer structures were produced in the same manner as in Example 5 to 10 except that the thickness of the hard coating layer was formed to be 3.5 μm.

### Examples 23 to 28

Glass substrate multilayer structures were produced in the same manner as in Example 5 to 10 except that the thickness of the hard coating layer was formed to be 3.0 μm.

### Examples 29 to 34

Glass substrate multilayer structures were produced in the same manner as in Example 5 to 10 except that the thickness of the hard coating layer was formed to be 2.5 μm.

### Comparative Example 1

A glass substrate multilayer structure was produced in the same manner as in Example 1, except that the shatterproof layer was formed using the shatterproof layer forming composition prepared in Preparation Example 5.

The physical properties of the glass substrate multilayer structures produced in Examples 1 to 34 and Comparative Example 1 are shown in the following Table 2.

TABLE 2

| | | | | | | Shatter | |
|---|---|---|---|---|---|---|---|
| | | | | Hard | | resistant | |
| | | | Shatterproof | coating | Surface | properties | Bending |
| | | | layer | layer | hardness | (results/1 m) | (unit: mm) |
| Example | 1 | Thickness | 5.0 | 4.8 | 5H | ⊚ | 0.03 |
| | | (μm) | | | | | |
| | | Composition | Preparation | Preparation | | | |
| | | | Example 1 | Example 6 | | | |
| | 2 | Thickness | 5.0 | 4.8 | 5H | ⊚ | 0.02 |
| | | (μm) | | | | | |
| | | Composition | Preparation | Preparation | | | |
| | | | Example 2 | Example 6 | | | |
| | 3 | Thickness | 5.0 | 4.8 | 5H | ⊚ | 0.01 |
| | | (μm) | | | | | |
| | | Composition | Preparation | Preparation | | | |
| | | | Example 3 | Example 6 | | | |
| | 4 | Thickness | 5.0 | 4.8 | 5H | ⊚ | 0.02 |
| | | (μm) | | | | | |
| | | Composition | Preparation | Preparation | | | |
| | | | Example 4 | Example 6 | | | |
| | 5 | Thickness | 0.5 | 4.8 | 5H | ⊚ | −0.45 |
| | | (μm) | | | | | |
| | | Composition | Preparation | Preparation | | | |
| | | | Example 3 | Example 6 | | | |
| | 6 | Thickness | 1.0 | 4.8 | 5H | ⊚ | −0.45 |
| | | (μm) | | | | | |
| | | Composition | Preparation | Preparation | | | |
| | | | Example 3 | Example 6 | | | |
| | 7 | Thickness | 1.5 | 4.8 | 5H | ⊚ | −0.45 |
| | | (μm) | | | | | |
| | | Composition | Preparation | Preparation | | | |
| | | | Example 3 | Example 6 | | | |
| | 8 | Thickness | 2.0 | 4.8 | 5H | ⊚ | −0.45 |
| | | (μm) | | | | | |
| | | Composition | Preparation | Preparation | | | |
| | | | Example 3 | Example 6 | | | |
| | 9 | Thickness | 2.5 | 4.8 | 5H | ⊚ | −0.42 |
| | | (μm) | | | | | |
| | | Composition | Preparation | Preparation | | | |
| | | | Example 3 | Example 6 | | | |
| | 10 | Thickness | 3.0 | 4.8 | 5H | ⊚ | −0.4 |
| | | (μm) | | | | | |
| | | Composition | Preparation | Preparation | | | |
| | | | Example 3 | Example 6 | | | |
| | 11 | Thickness | 0.5 | 4.0 | 5H | ⊚ | −0.4 |
| | | (μm) | | | | | |
| | | Composition | Preparation | Preparation | | | |
| | | | Example 3 | Example 6 | | | |
| | 12 | Thickness | 1.0 | 4.0 | 5H | ⊚ | −0.4 |
| | | (μm) | | | | | |
| | | Composition | Preparation | Preparation | | | |
| | | | Example 3 | Example 6 | | | |
| | 13 | Thickness | 1.5 | 4.0 | 5H | ⊚ | −0.37 |
| | | (μm) | | | | | |
| | | Composition | Preparation | Preparation | | | |
| | | | Example 3 | Example 6 | | | |
| | 14 | Thickness | 2.0 | 4.0 | 5H | ⊚ | −0.36 |
| | | (μm) | | | | | |
| | | Composition | Preparation | Preparation | | | |
| | | | Example 3 | Example 6 | | | |
| | 15 | Thickness | 2.5 | 4.0 | 5H | ⊚ | −0.36 |
| | | (μm) | | | | | |
| | | Composition | Preparation | Preparation | | | |
| | | | Example 3 | Example 6 | | | |
| | 16 | Thickness | 3.0 | 4.0 | 5H | ⊚ | −0.31 |
| | | (μm) | | | | | |
| | | Composition | Preparation | Preparation | | | |
| | | | Example 3 | Example 6 | | | |
| | 17 | Thickness | 0.5 | 3.5 | 5H | ⊚ | −0.37 |
| | | (μm) | | | | | |
| | | Composition | Preparation | Preparation | | | |
| | | | Example 3 | Example 6 | | | |
| | 18 | Thickness | 1.0 | 3.5 | 5H | ⊚ | −0.35 |
| | | (μm) | | | | | |
| | | Composition | Preparation | Preparation | | | |
| | | | Example 3 | Example 6 | | | |
| | 19 | Thickness | 1.5 | 3.5 | 5H | ⊚ | −0.29 |
| | | (μm) | | | | | |
| | | Composition | Preparation | Preparation | | | |
| | | | Example 3 | Example 6 | | | |
| | 20 | Thickness | 2.0 | 3.5 | 5H | ⊚ | −0.25 |
| | | (μm) | | | | | |
| | | Composition | Preparation | Preparation | | | |
| | | | Example 3 | Example 6 | | | |
| | 21 | Thickness | 2.5 | 3.5 | 5H | ⊚ | −0.21 |
| | | (μm) | | | | | |
| | | Composition | Preparation | Preparation | | | |
| | | | Example 3 | Example 6 | | | |
| | 22 | Thickness | 3.0 | 3.5 | 5H | ⊚ | −0.18 |
| | | (μm) | | | | | |
| | | Composition | Preparation | Preparation | | | |
| | | | Example 3 | Example 6 | | | |
| | 23 | Thickness | 0.5 | 3.0 | 5H | ⊚ | −0.3 |
| | | (μm) | | | | | |
| | | Composition | Preparation | Preparation | | | |
| | | | Example 3 | Example 6 | | | |
| | 24 | Thickness | 1.0 | 3.0 | 5H | ⊚ | −0.25 |
| | | (μm) | | | | | |
| | | Composition | Preparation | Preparation | | | |
| | | | Example 3 | Example 6 | | | |
| | 25 | Thickness | 1.5 | 3.0 | 5H | ⊚ | −0.16 |
| | | (μm) | | | | | |
| | | Composition | Preparation | Preparation | | | |
| | | | Example 3 | Example 6 | | | |
| | 26 | Thickness | 2.0 | 3.0 | 5H | ⊚ | −0.09 |
| | | (μm) | | | | | |
| | | Composition | Preparation | Preparation | | | |
| | | | Example 3 | Example 6 | | | |
| | 27 | Thickness | 2.5 | 3.0 | 5H | ⊚ | −0.02 |
| | | (μm) | | | | | |
| | | Composition | Preparation | Preparation | | | |
| | | | Example 3 | Example 6 | | | |
| | 28 | Thickness | 3.0 | 3.0 | 5H | ⊚ | 0.01 |
| | | (μm) | | | | | |
| | | Composition | Preparation | Preparation | | | |
| | | | Example 3 | Example 6 | | | |
| | 29 | Thickness | 0.5 | 2.5 | 5H | ⊚ | −0.21 |
| | | (μm) | | | | | |
| | | Composition | Preparation | Preparation | | | |
| | | | Example 3 | Example 6 | | | |
| | 30 | Thickness | 1.0 | 2.5 | 4H | ⊚ | −0.16 |
| | | (μm) | | | | | |
| | | Composition | Preparation | Preparation | | | |
| | | | Example 3 | Example 6 | | | |
| | 31 | Thickness | 1.5 | 2.5 | 4H | ⊚ | −0.11 |
| | | (μm) | | | | | |
| | | Composition | Preparation | Preparation | | | |
| | | | Example 3 | Example 6 | | | |
| | 32 | Thickness | 2.0 | 2.5 | 4H | ⊚ | −0.05 |
| | | (μm) | | | | | |
| | | Composition | Preparation | Preparation | | | |
| | | | Example 3 | Example 6 | | | |
| | 33 | Thickness | 2.5 | 2.5 | 4H | ⊚ | 0.09 |
| | | (μm) | | | | | |
| | | Composition | Preparation | Preparation | | | |
| | | | Example 3 | Example 6 | | | |
| | 34 | Thickness | 3.0 | 2.5 | 4H | ⊚ | 0.12 |
| | | (μm) | | | | | |
| | | Composition | Preparation | Preparation | | | |
| | | | Example 3 | Example 6 | | | |
| Comparative | 1 | Thickness | 5.0 | 4.8 | 5H | ⊚ | −2.3 |
| Example | | (μm) | | | | | |
| | | Composition | Preparation | Preparation | | | |
| | | | Example 5 | Example 6 | | | |

As seen in Table 2, it was found that Examples 1 to 34 had an excellent surface hardness of 4H or more, and also, it was confirmed that shatter resistant and impact resistance properties were excellent at a height of 1 m. Furthermore, bending properties were within ±0.45 mm which showed a significantly low value of a bending occurrence.

The glass substrate multilayer structure of the present disclosure has a high surface hardness, is flexible, and has excellent thermal resistance and optical properties.

In addition, the glass substrate multilayer structure of the present disclosure is formed by forming a polyimide-based shatterproof layer on one surface of a flexible glass substrate and forming an epoxy siloxane-based hard coating layer on the polyimide-based shatterproof layer, thereby having an effect of preventing the deformation of the glass substrate itself or the deformation of the glass substrate multilayer structure due to an external stress such as thermal hysteresis so that long-term deformation does not occur.

In addition, the glass substrate multilayer structure of the present disclosure has an epoxy siloxane-based hard coating layer formed on a polyimide-based shatterproof layer showing a different thermal behavior, thereby surprising effects of suppressing the thermal deformation of a flexible glass substrate, suppressing the deformation of the polyimide-based shatterproof layer and the epoxy siloxane-based hard coating layer to each other, and also suppressing a bending occurrence of a glass multilayer structure.

Furthermore, the polyimide-based shatterproof layer and the epoxy siloxane-based hard coating layer have a thickness of 5 μm or less, whereby a bending occurrence of a glass substrate multilayer structure is significantly suppressed, a shattering phenomenon when the glass substrate is broken is improved, and a significantly improved effect of shatter resistant (ball drop) properties and a surface hardness of 4H or more in accordance of ASTM D3363 may be implemented.

Hereinabove, although the present disclosure has been described by specific matters, limited exemplary embodiments, and drawings, they have been provided only for assisting the entire understanding of the present disclosure, and the present disclosure is not limited to the exemplary embodiments, and various modifications and changes may be made by those skilled in the art to which the present disclosure pertains from the description.

Therefore, the spirit of the present disclosure should not be limited to the above-described exemplary embodiments, and the following claims as well as all modified equally or equivalently to the claims are intended to fall within the scope and spirit of the disclosure.

What is claimed is:

1. A glass substrate multilayer structure comprising:
a flexible glass substrate;
a polyimide-based shatterproof layer formed on one surface of the flexible glass substrate; and
an epoxy siloxane-based hard coating layer formed on the polyimide-based shatterproof layer,
wherein the polyimide-based shatterproof layer has a coefficient of thermal expansion (CTE) at 100° C. to 200° C. of 50 to 80 ppm.

2. The glass substrate multilayer structure of claim 1, wherein the polyimide-based shatterproof layer is formed of a polyimide resin comprising a unit derived from a fluorine-based aromatic diamine and a unit derived from an aromatic dianhydride.

3. The glass substrate multilayer structure of claim 1, wherein the epoxy siloxane-based hard coating layer is formed of an epoxy siloxane-based resin comprising a unit derived from an alicyclic epoxidized silsesquioxane-based compound.

4. The glass substrate multilayer structure of claim 1, wherein the flexible glass substrate has a thickness of 1 to 100 μm.

5. The glass substrate multilayer structure of claim 1, wherein the polyimide-based shatterproof layer has a thickness of 100 nm to 5 μm.

6. The glass substrate multilayer structure of claim 1, wherein the polyimide-based shatterproof layer has a pencil hardness of HB in accordance with ASTM D3363.

7. The glass substrate multilayer structure of claim 1, wherein the polyimide-based shatterproof layer has a value within a range of +1.5 mm to +2.0 mm in bending properties (the bending properties are obtained by measuring a bending degree of the glass substrate multilayer structure at room temperature, immediately after forming the polyimide-based shatterproof layer on a glass substrate having a width of 180 mm×a length of 76 mm×a thickness of 40 μm, and when the glass substrate multilayer structure is curved in a direction of a vibration isolation table and a center of the glass substrate is curved to an air layer, the value is represented as a negative (stress) value (mm) and conversely, when both ends (edges) of the glass substrate are curved in a direction of the air layer on the vibration isolation table, the value is represented as a positive (tension) value (mm)).

8. The glass substrate multilayer structure of claim 1, wherein the epoxy siloxane-based hard coating layer has a thickness of 1 μm to 10 μm.

9. The glass substrate multilayer structure of claim 1, wherein the epoxy siloxane-based hard coating layer has a pencil hardness of 4H to 6H in accordance with ASTM D3363.

10. The glass substrate multilayer structure of claim 1, wherein the epoxy siloxane-based hard coating layer has a transmittance of 90% or more.

11. The glass substrate multilayer structure of claim 1, wherein the epoxy siloxane-based hard coating layer has a value within a range of −1.0 mm to −1.5 mm (the bending properties are obtained by measuring a bending degree of the glass substrate multilayer structure at room temperature, immediately after forming the hard coating layer on a glass substrate having a width of 180 mm×a length of 76 mm×a thickness of 40 μm, and when the glass substrate multilayer structure is curved in a direction of a vibration isolation table and a center of the glass substrate is curved to an air layer, the value is represented as a negative (stress) value (mm) and conversely, when both ends (edges) of the glass substrate are curved in a direction of the air layer on the vibration isolation table, the value is represented as a positive (tension) value (mm)).

12. The glass substrate multilayer structure of claim 1, wherein the glass substrate multilayer structure has shatter resistant properties of 1 m or more in accordance with a pen drop test.

13. The glass substrate multilayer structure of claim 1, wherein the glass substrate multilayer structure has a value within ±0.5 mm in bending properties (the bending properties are obtained by measuring a bending degree of the glass substrate multilayer structure at room temperature, immediately after forming the polyimide-based shatterproof layer and the hard coating layer on a glass substrate having a width of 180 mm×a length of 76 mm×a thickness of 40 μm, and when the glass substrate multilayer structure is curved in a direction of a vibration isolation table and a center of the glass substrate is curved to an air layer, the value is represented as a negative (stress) value (mm) and conversely, when both ends (edges) of the glass substrate are curved in a direction of the air layer on the vibration isolation table, the value is represented as a positive (tension) value (mm)).

14. A method of producing a glass substrate multilayer structure, the method comprising:
applying a shatterproof composition on one surface of a flexible glass substrate and curing the shatterproof composition to form a polyimide-based shatterproof layer; and
applying a hard coating composition on the polyimide-based shatterproof layer and curing the hard coating composition to form an epoxy siloxane-based hard coating layer.

15. The method of producing a glass substrate multilayer structure of claim 14, wherein the shatterproof composition comprises a fluorine-based aromatic diamine and an aromatic dianhydride.

16. The method of producing a glass substrate multilayer structure of claim 14, wherein the epoxy siloxane-based hard coating composition comprises an epoxy siloxane-based resin comprising a unit derived from an alicyclic epoxidized silsesquioxane-based compound, a crosslinking agent, and a photoinitiator.

17. A flexible display panel comprising the glass substrate multilayer structure of claim 1.
